(19) United States
(12) Patent Application Publication
(10) Pub. No.: US 2005/0230557 A1
(43) Pub. Date: Oct. 20, 2005

(54) Zero-G emulating testbed for spacecraft control system

(75) Inventor: Farhad Aghili, Brossard (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: Canadian Space Agency

(21) Appl. No.: 11/019,569

(22) Filed: Dec. 23, 2004

Related U.S. Application Data
(60) Provisional application No. 60/532,890, filed on Dec. 30, 2003.

(51) Int. Cl. B64G 7/00; B64G 5/00

(52) U.S. Cl. 244/158.1

(57) ABSTRACT

The present invention provides an emulation system having a control system that allows the testing of a satellite control system with all of its hardware in place, i.e. fully integrated. The emulation methodology is applicable to the case of either a rigid spacecraft or a flexible spacecraft, provided that the spacecraft's sensors and actuators are stowed to the rigid part of spacecraft in the case of a flexible spacecraft. Practically, the latter condition is not restrictive, as the actuators and sensors are usually placed rigidly in the satellite bus, while the satellite solar panels constitute the flexible elements. The control system is used to tune the mass properties and dynamic behaviour of a rigid ground-spacecraft in a 1-G environment to those of a flight-spacecraft in 0-G. A six-axis force/moment sensor is placed at an interface of the ground-spacecraft and a manipulator. Signals received from the force/moment sensor, and in some cases signals relating to the position and velocity of manipulator joints, are received into the control system.

### CROSS-REFERENCE TO RELATED APPLICATIONS

This application claims the benefit of U.S. Provisional Application No. 60/532,890, filed Dec. 30, 2003, which is incorporated herein by reference.

### FIELD OF THE INVENTION

The present invention relates generally to the emulation of zero-gravity conditions in an environment where the effects of gravity are otherwise present. More particularly, the present invention relates to zero-gravity (0-G) emulation of a spacecraft in an earthbound (1-G) laboratory environment using a controlled manipulator.

### BACKGROUND OF THE INVENTION

The greatest challenge in implementing an advanced control system for spacecraft is that ground-based testing must take place in a 1-G environment, whereas the eventual hardware system will operate in a 0-G environment. Simulation is widely used for characterizing the functional behavior of spacecraft control systems. However, it is of vital importance to be able to test and validate the system performance under realistic conditions and through maximum use of hardware. Therefore, in the aerospace industry, it is highly desirable to incorporate actual hardware, as much as possible, in the simulation loop. Validation and testing of the functional capability of spacecraft attitude/translation control systems with real physical units on the ground poses many challenges due to the effects of gravity. Moreover, in the design phase, one must choose adequate spacecraft control subsystem components, such as actuators and sensors, with specific characteristics based on the control objectives.

The motion dynamics of a spacecraft, consisting of its orbital motion and its attitude motion, can be accurately captured by translational and rotational equations. Attitude in this context refers to the position of a body, such as an aircraft or spacecraft, as determined by the inclination of the axes to some frame of reference. If not otherwise specified, this frame of reference is fixed to the Earth. Orbital motion refers to motion in the direction of orbit, i.e. along a path described by one body in its revolution about another, as by a spacecraft about the earth or another body.

However, a complete simulation of a spacecraft requires modelling of the sensor and control actuation of a spacecraft equipped with an active control system. The sensors and actuators have complex dynamics characteristics. Often, simplified models are used for simulation. This implies that characteristics of the eventual control system, that depend on various subsystem components, e.g., sensors, actuators, electronics, control software, etc., can not be fully investigated and measured until the spacecraft is placed in orbit.

Gas-jet thrusters, ion thrusters, and balanced reaction wheels are examples of devices commonly employed as actuators for spacecraft attitude and/or translation control. Due to the complexity of the dynamics associated with these actuators, a hardware test on the ground is required for verification. This requires that the ground spacecraft equipped with its actuators behaves dynamically as a free-flying object, or a flight-spacecraft in the orbit, in spite of the laboratory 1-G environment.

Two existing spacecraft testing technologies are motion table systems and air bearing systems. Motion table systems, such as multi-axis motion controlled tables, that replicate the motion of a satellite, have been used for Hardware-In-The-Loop testing of an attitude control system (ACS). For instance, a motion table system has been developed for testing star tracker and gyros of a satellite in Ng, Alfred C. et al. “Odin Attitude Control System Testing—An International Collaboration” from 4^{th} ESA International Conference on Spacecraft Guidance, Navigation and Control Systems, 18-21 Oct. 1999, ESTEC, Noordwijk, The Netherlands. The motion table testing system allows the incorporation of real sensors of a satellite such as gyro and star tracker in the simulation loop. Actuators, such as reaction wheels, torques, or gas-jet thrusters must be simulated in this method, which constitute its main limitation. Also, the number of degrees-of-freedom is limited in this method. Usually this system is limited to two degrees of freedom, i.e. it is a 2-axis system.

Another common testing procedure is to use an air bearing system. An air bearing table and spherical air bearings are common device arrangements used as a ground-based testbed for testing hardware of spacecraft translation and attitude control systems. An emulation of 0-G translational motion can be produced by an air bearing table where the spacecraft can navigate along a surface perpendicular to the gravity vector, while being floated on a cushion of compressed air with almost no resistance. This technique is widely used for testing various systems such as gas thruster systems (for attitude and/or translation control of an spacecraft), free-flying space robots, and docking and capturing mechanism of spacecraft. Although the air bearing table system can be utilized to test physical units of spacecraft control systems including the sensors and actuators, this system is limited to a two-dimensional planar case that is not representative of reality, because the spacecraft dynamics in a planar environment are substantially simpler than in a 3-D environment.

Spherical air bearings have been used for spacecraft attitude determination and control hardware verification and software development for more than four decades. A historical review of air-bearing spacecraft simulators and contemporary state-of-the-art technology and facilities in different government and university laboratories can be found in J. L. Schwartz and et. al. “Historical Review of Air Bearing Spacecraft Simulators” in AIAA Journal of Guidance, Control and Dynamics, Vol. 26, No. 4, July-August 2003. An air bearing yields minimum friction, and, hence, offers a nearly torque-free environment if the center of mass is coincident with the bearing's center of rotation. The main problem with the air bearing system is the limited range of motion caused by the equipment affixed to the bearing limits. Moreover, achieving all translational motion and rotational motion in a force/torque-free fashion is very difficult and requires a very complex system. Also, an air bearing simulator is suitable only for rigid spacecrafts.

In currently known test systems, air bearing systems with planar and spherical configurations exist for simulating the translational motion and rotational motion of spacecraft. However, the following drawbacks exist: the actuators on the satellite control system are simulated; the simulation is not performed in a 3-D environment; and/or the range of rotational motion is limited. Also, it is not possible in such known systems to test a spacecraft which has flexible elements, such as a solar panel. An air bearing system is a passive system, which only minimizes friction. There is no feedback in such systems, and it is not possible to change inertia, or parameters of a dynamics model of a spacecraft.

It is also possible to use a free-fall test to achieve zero-gravity in a 3-D environment, albeit for only a short period of time. However, the free-fall test requires very expensive equipment and the test is sustainable for only a short period of time. Submerging a spacecraft in an underwater test tank is a low-fidelity solution; this is mainly used for astronaut training.

It is, therefore, desirable to provide an emulation system for use with a ground spacecraft that can test the spacecraft in three dimensions, in a 1-G environment, with real sensors and actuators in place.

### SUMMARY OF THE INVENTION

It is an object of the present invention to obviate or mitigate at least one disadvantage of previous ground-based testbed systems for testing a spacecraft and control systems employed in such spacecraft.

The present invention provides an active emulation system that makes use of both force and motion feedback. This reduces system uncertainty, and reduces the need for calibration, counterbalancing, and minimizing friction. Feedback is used to virtually change inertia parameters to the desired inertia parameters. Such a system can accurately emulate in three dimensions and in a 1-G environment a flight-spacecraft using a ground spacecraft that has real sensors and actuators on-board.

In a first aspect, the present invention provides a method of emulating a zero-gravity (0-G) environment for a ground-spacecraft that emulates a flight-spacecraft in three dimensions. The ground-spacecraft is placed in an emulation system including a manipulator having a plurality of joints, and a control system. The method includes the following steps: receiving, at the control system, a feedback signal having a generalized force component and a motion component; removing components of gravitational force from the generalized force component; determining a desired trajectory of the manipulator based on the received feedback signal, on parameters of a dynamics model of the ground-spacecraft, and on parameters of a dynamics model of the flight-spacecraft; calculating a desired control command to be applied to the manipulator based on the determined desired trajectory; and issuing a control command to the manipulator in order to achieve ground-spacecraft dynamic motion corresponding substantially to a desired dynamic motion of the flight-spacecraft in 0-G.

The step of determining the desired trajectory of the manipulator can include replicating dynamic motion of a flight-spacecraft described in one of an inertial frame or a moving frame attached to an observing satellite in neighbouring orbit. The step of determining the desired trajectory of the manipulator can include emulating, at the ground-spacecraft, the motion dynamics of the flight-spacecraft with respect to another spacecraft in neighbouring orbit. The step of removing components of gravitational force from the generalized force component can include compensating the force/moment sensor signals for the gravity of the ground-spacecraft. The parameters of the dynamics model of the ground-spacecraft are selected from the group consisting of mass and inertia. The parameters of the dynamics model of the flight-spacecraft are selected from the group consisting of inertia, mass, stiffness, and damping.

The ground-spacecraft can have components in a flexural coordinate and a rigid coordinate. In that case, the step of determining desired trajectory of the manipulator can include the steps of: removing components due to unknown actuation forces; decoupling the equations of acceleration of the flexural coordinates and rigid coordinates; and deriving the equation of the desired joint-acceleration as functions of joint quantities by making use of manipulator kinematics mapping. The step of removing components due to unknown actuation forces can include: subtracting equations of motion of the ground-spacecraft from equations of motion of the flight-spacecraft. The step of decoupling the equations of acceleration of the flexible coordinate and rigid coordinate can include the steps of: calculating acceleration of the flexible coordinate based on the feedback signal; and obtaining the flexible state as a result of numerical integration of the acceleration. The step of decoupling the equations of acceleration of the flexible coordinate and rigid coordinate can include the step of: using equations of acceleration of the rigid coordinate and manipulator kinematics to calculate estimated joint acceleration of the manipulator.

In another aspect, the present invention provides an emulation system which emulates a zero-gravity environment for testing in three-dimensions a ground-spacecraft having sensors and actuators on-board. The emulation system includes the following: a manipulator for manipulating the ground-spacecraft, the manipulator having a plurality of joints for receiving a motion component signal; a force/moment sensor in communication with the manipulator and the ground-spacecraft for receiving a generalized force component signal; and a control system for receiving and processing a feedback signal based on the received generalized force component signal and on the motion component signal and for controlling the dynamic behavior of the manipulator together with the ground-spacecraft based on the processed feedback signal in order to achieve ground-spacecraft dynamic motion corresponding to a desired dynamic motion of a flight-spacecraft in 0-G.

The manipulator can include a plurality of manipulator joint sensors attached to the plurality of joints. The control system can further include a flexible state simulator for simulating a flexible component of the flight-spacecraft. The control system can include means for removing components of gravitational force from the generalized force component signal. The control system can include means for determining a desired joint-acceleration trajectory of the manipulator based on the feedback signal, on parameters of a dynamics model of the ground-spacecraft, on parameters of a dynamics model of the flight-spacecraft, and on parameters of dynamics model of the manipulator. The control system ca include means for calculating a desired control command to be applied to the manipulator based on the determined desired trajectory. The control system can include means to issue a torque command to the manipulator to achieve the desired dynamic motion of a flight-spacecraft in 0-G. The force/moment sensor can be a six-axis force/moment sensor, and can be placed at the interface of the manipulator's end-effector and the ground-spacecraft. The manipulator can be a robotic manipulator, or a robotic arm having seven joints driven by electric motors.

In a further aspect, the present invention provides a control system for use with an emulation system which emulates a zero-gravity environment for testing in three-dimensions a ground-spacecraft having sensors and actuators on-board. The emulation system includes a manipulator for manipulating the ground-spacecraft, the manipulator having a plurality of joints for receiving a motion component signal, and a force/moment sensor in communication with the manipulator and the ground-spacecraft for receiving a generalized force component signal. The control system includes: a receiver for receiving a feedback signal having components in three dimensions, the feedback signal being based on the generalized force component signal and the motion component signal; a processor for determining a desired trajectory of the manipulator based on the received feedback signal, on parameters of a dynamics model of the ground-spacecraft, and on parameters of a dynamics model of the flight-spacecraft, and for calculating a desired control command to be applied to the manipulator based on the determined desired trajectory; and a controller for controlling dynamic behavior of the ground-spacecraft so that dynamic motion of the ground-spacecraft corresponds substantially to the desired dynamic motion of the flight-spacecraft in 0-G.

The control system can further include a flexible state simulator for simulating a flexible component of the flight-spacecraft. The motion component signal can include information relating to the position and velocity of the joints. The controller can include means for controlling the dynamic behavior of the manipulator and the ground-spacecraft such that inertial parameters of the manipulator and the ground-spacecraft are combined so as to be substantially equivalent to desired target spacecraft inertial parameters. In such a case, the control system can further include means for customizing the desired target spacecraft inertial parameters. The control system can further include a computer-readable memory having recorded thereon sequences and instructions for execution by the controller to control the dynamic behavior of the ground-spacecraft so that dynamic motion of the ground-spacecraft corresponds substantially to the desired dynamic motion of the flight-spacecraft in 0-G.

The controller can include means for issuing torque commands to the manipulator to achieve the desired dynamic motion of the flight-spacecraft in 0-G. The controller can include means for issuing torque commands in response to manipulator joint angles and velocities measured at the joints. The control system can further include an estimator for performing one of: a computation of a gravitational force based on a measured attitude of an end effector of the manipulator; and an estimation of a gravitational force/moment of the ground-spacecraft on the six-axis force/moment sensor. The control system can further include means for determining the attitude by measuring manipulator joint angles. The control system can further include means for subtracting an estimated gravitational force from a received force feedback signal. The control system can further include a calibrator for performing one of: a measurement of the orientation of an end-effector of the manipulator with respect to the gravity vector, upon which measurements is based the estimated gravitational force/moment; and a measurement of values of mass and center of mass of the of the ground-spacecraft, upon which measurements is based the estimated gravitational force. The controller can be a non-linear controller.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a diagrammatic representation of an emulation system incorporating a control system according to an embodiment of the present invention;

FIG. 2 is a flowchart showing a method of emulating a zero-gravity environment according to an embodiment of the present invention;

FIG. 3 is a flowchart showing a method of emulating a zero-gravity environment according to another embodiment of the present invention;

FIG. 4 is a schematic of the flight-spacecraft showing its relative position and orientation in two neighbouring orbits;

FIG. 5 is a block diagram illustrating an emulation system incorporating a control system according to an embodiment of the present invention; and

FIG. 6 is a diagrammatic representation of a second emulation system incorporating a control system according to an embodiment of the present invention.

### DETAILED DESCRIPTION

Generally, the present invention provides an emulation system having a control system that allows the testing of a satellite control system with all of its hardware in place, i.e. fully integrated. The emulation methodology is applicable to the case of either a rigid spacecraft or a flexible spacecraft, provided that the spacecraft's sensors and actuators are stowed to the rigid part of spacecraft in the case of a flexible spacecraft. Practically, the latter condition is not restrictive, as the actuators and sensors are usually placed rigidly in the satellite bus, while the satellite solar panels constitute the flexible elements. The control system is used to tune the mass properties and dynamic behavior of a rigid ground-spacecraft in a 1-G environment to those of a flight-spacecraft in 0-G. A six-axis force/moment sensor is placed at an interface of the ground-spacecraft and a manipulator. Signals received from the force/moment sensor, and in some cases signals relating to the position and velocity of manipulator joints, are received into the control system.

In the description, reference to a 1-G environment is to be understood as referring to an earthbound or ambient pressure environment. Practically speaking, an environment of exactly 1-G will be only likely achieved in exceptional circumstances. Any earthbound environment closely approximating a 1-G environment is to be understood as forming part of the expression 1-G environment as used herein.

A system according to an embodiment of the present invention is provided to test a spacecraft control system, such as a satellite control system, with real sensors and real actuators attached thereto. The system ensures that the collective inertia, or dynamic motion, of the manipulator and the ground-spacecraft is substantially equivalent to the desired inertia of the flight-spacecraft.

Force feedback is used in such a control system in order to achieve this result. The control system in the present invention uses signals received from a sensor, such as a force/moment sensor, and signals relating to joint position and velocity in order to calculate the inertia of the robot manipulator and the ground-satellite. The control system then changes the dynamic behavior of the manipulator and the ground-spacecraft by issuing torque commands so that the combined inertia of the manipulator and the ground-spacecraft results in desired target satellite inertial parameters. Even though the testing ground-spacecraft is rigid, the control system emulates a dynamic motion of a flexible spacecraft.

In a specific embodiment of the invention, the control system emulates the spacecraft in a zero-G environment as follows. As will be explained later, not all of these steps are necessary for implementation of embodiments of the present invention. In this particular embodiment, the equations of motion of the ground-spacecraft are subtracted from those of the flight-spacecraft. This eliminates the unknown actuation force. The equations of acceleration of the flexural coordinates and the base coordinates are decoupled and then they are derived as functions of the joint coordinate quantities by making use of manipulator kinematics mapping. Calculation of the acceleration of the flexural coordinate is preferably based on the feedback signal inputs, and the flexural state is preferably obtained as a result of numerical integration of the acceleration. The equation of acceleration of rigid coordinates and the manipulator kinematics are preferably used to calculate estimated joint acceleration of the manipulator. Subsequently, manipulator joint torque is calculated based on inverse dynamics of the manipulator and the given acceleration. Finally, issuing the torque command(s) to the manipulator achieves the desired dynamic motion of the flight-spacecraft in 0-G.

The forces are calculated according to various equations, which will be discussed in more detail below. The target flight-spacecraft inertial parameters can be set to any desired values. Consequently, the control system can tune the mass properties of the testing ground-spacecraft and even its dynamic behavior according to a model of the flight-spacecraft. In other words, given the desired mass properties, feedback is used to achieve such desired mass properties. Target dynamics can be assigned, and mass properties such as mass, inertia, stiffness, and Coriolis force can be assigned. Such an arrangement makes it also possible not only to be able to scale the inertia of the testing spacecraft but also to create the motion perturbation induced by flexible components of the flight-spacecraft while the testing ground-spacecraft itself lacks any flexible components.

A new methodology for emulation of a rigid or flexible spacecraft using an actively controlled manipulator is discussed. This can be used as a testbed for testing all components of a spacecraft attitude and/or translation control system including the sensors, actuators, and the spacecraft controller. In this method, a manipulator picks a rigid ground-spacecraft which is endowed with an active motion control system. An echo of the spacecraft actuation force superimposed by gravitational and inertial forces is sensed by a wrist force/moment sensor and the corresponding signals are fed to the manipulator control system, which moves the manipulator and the ground-spacecraft accordingly. The control system ensures that the motion dynamics on the ground coincides with what would be encountered in a 0-G environment. Only the hardware system relating to the spacecraft motion control system, e.g. spacecraft bus, needs to undergo the test, while the dynamics of the missing inertia and/or the flexible element can be well compensated for by the emulating control system. A simple calibration procedure for compensation of the 1-G laboratory environment is discussed. Preliminary experiments have been performed using the CSA Autonomous Robotics Testbed (CART).

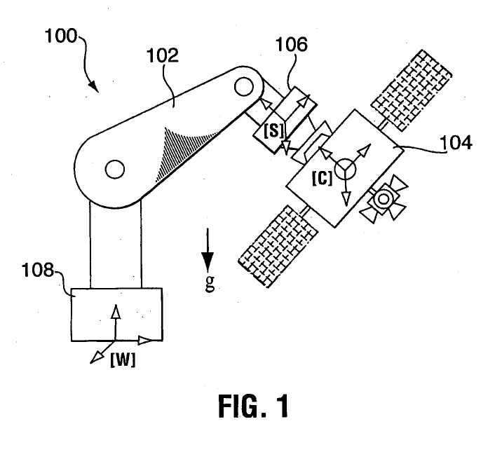

FIG. 1 is a diagrammatic representation of an emulation system incorporating a control system according to an embodiment of the present invention. The emulation system 100 is comprised of three functional subsystems: a manipulator 102, such as a rigid manipulator; a ground-spacecraft 104, such as a satellite prototype, or a “real” spacecraft or satellite; and a control system 108.

The manipulator 102 can be a robot, such as one of the robotic arms of the Canadian Space Agency's Autonomous Robotics Testbed (CART). A particular arm used as a manipulator in embodiments of the present invention has seven joints driven by electric motors. Although the motion of a free-flying spacecraft needs only 6 degrees of freedom (DOF), the extra degrees-of-freedom of the arm can be exploited to maximize the volume of working space.

The emulation system 100 includes a force/moment sensor 106 connected to the manipulator 102. Although a force/moment sensor 106 is illustrated in this embodiment, alternative implementations are possible. For instance, a six-axis accelerometer can be used, preferably in conjunction with a sensor in the joints, such as an encoder and tachometer. The sensor 106 is preferably mounted at the mechanical interface between the manipulator 102 and the testing ground-spacecraft 104. This interface is referred to as the wrist, or the end-effector, of the manipulator arm. The six-axis force/moment sensor 106 is used in order to implement a desired control law, as will be described below. The term “control law” as used in this specification is a common term in the art used to designate a control relationship that has been determined to be true for a particular arrangement.

The ground-spacecraft 104 can be a mockup of a satellite, such as a mockup resembling the Quicksat™, a research satellite being developed at the Canadian Space Agency. An engineering model of the satellite, with realistic hardware in place, can be preferably employed in the emulation system. Two solar panels are shown attached to the ground-spacecraft 104 in dotted lines in FIG. 1. These solar panels, although possibly present in the flight-spacecraft, are not physically present on the ground-spacecraft. However, they are shown in dotted lines in FIG. 1 since the effects of flexible components, such as a solar panel, can be emulated in an emulation system according to an embodiment of the present invention. This allows the emulation of the flexible components of a flight-spacecraft without the ground-spacecraft itself requiring a flexible component.

It should be pointed out that the inertial parameters of the ground-spacecraft are not necessarily representative of reality. Nevertheless, the control system establishes motion dynamics dictated by a set of desired inertial parameters. Since the ground-spacecraft is the manipulator's payload, it is desirable to use a ground-spacecraft which is as light as possible. Moreover, if the inertia parameters of the ground-spacecraft are selected to be equal to that of the flight-spacecraft then the control demands infinite joint torque. To minimize the force feedback gain, and, hence, reduce control effort, the combined inertia of the manipulator and ground-spacecraft should be as close as possible to that of the flight-spacecraft. Various tests are possible with this system, such as: attitude and/or translation control using nitrogen gas propulsive thrusters; deployment of an antenna or a solar panel; and capture of a satellite using a docking mechanism.

The control system 108, such as a non-linear controller, is a key component of the emulation system 100. A control algorithm, preferably stored in a computer-readable memory provided in the control system 108, ensures that the combined system of the robot and ground-spacecraft replicates the dynamic behavior of a flight-spacecraft in free-space. The flight-spacecraft, such as a satellite, is characterized by a set of desired inertial parameters, or dynamic motion parameters, that are different from those of the ground-spacecraft. The control system 108 makes use of the inertial parameters of the ground-spacecraft (typically the manipulator's payload), plus the manipulator; takes the measurement of joint angles, velocities, and the wrist force/moment; and then issues joint torque command(s) to produce adequate motion trajectory according to that of the flight-spacecraft.

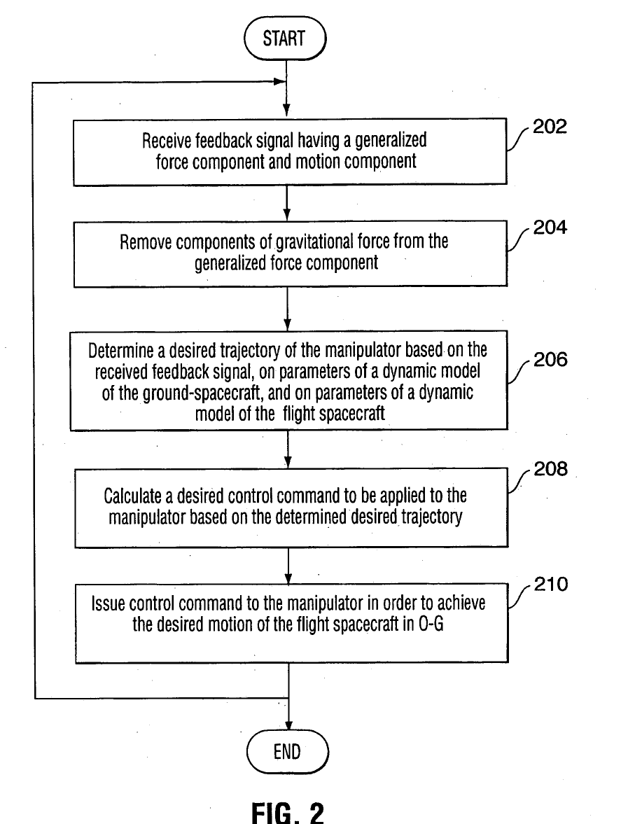

The operation of the control system 108 is preferably guided by a method, which can be embodied in code or instructions stored in a computer-readable memory which, when executed, performs the steps of the method. Such a method will now be described in relation to FIG. 2. The steps illustrated in FIG. 2 are general in nature, and specific implementations of the various steps will be described in further detail later in the description.

FIG. 2 is a flowchart showing a method of emulating a zero-gravity environment according to an embodiment of the present invention. FIG. 2 relates to a method of emulating a zero-gravity (0-G) environment for a ground-spacecraft that emulates a flight-spacecraft. The method can use the ground-spacecraft to emulate the flight-spacecraft in three dimensions. The ground-spacecraft can have sensors and actuators on-board. The ground-spacecraft is placed in an emulation system including a manipulator having a plurality of joints and a control system. The emulation system can include a force/moment sensor, and can include a plurality of manipulator joint sensors attached to the plurality of joints.

The method includes the following steps. In step 202, a feedback signal having a generalized force component and a motion component is received at the control system. The generalized force component can include signals sensed at the force/moment sensor. The generalized force component is typically composed of three components: an inertial component; a gravitational component; and an external force component. The inertial component is typically a result of the generalized motion of the ground-spacecraft in Cartesian space. The gravitational component is a result of gravity. The external force component is a result of a summation of all external forces, typically including forces at the actuators on the ground-spacecraft. The motion component can include joint angles and joint velocities sensed at the joints, such as at joint sensors and/or encoders. In certain embodiments, the joint angles and velocities can each have six components.

In step 204, the components of gravitational force are removed from the generalized force component of the feedback signal. In step 206, a desired trajectory of the manipulator is determined, and can be an estimation of joint angle trajectory. This determination, or estimation, is based on the received feedback signal, on parameters of a dynamics model of the ground-spacecraft, and on parameters of a dynamics model of the flight-spacecraft. In step 208, a desired control command to be applied to the manipulator is calculated based on the determined desired trajectory. Then, in step 210, a control command is issued to the manipulator in order to achieve ground-spacecraft dynamic motion corresponding substantially to the desired dynamic motion of the flight-spacecraft in 0-G. Of course, any number of control commands can be issued as part of step 210. Steps 204-208 can advantageously be implemented in software, and steps 202 and 210 can be controlled by such software.

The method described in relation to FIG. 2 is a generalized method that can be applied to emulating both a rigid spacecraft and a flexible spacecraft, or a spacecraft with rigid and flexible components, or components in rigid and flexible coordinates.

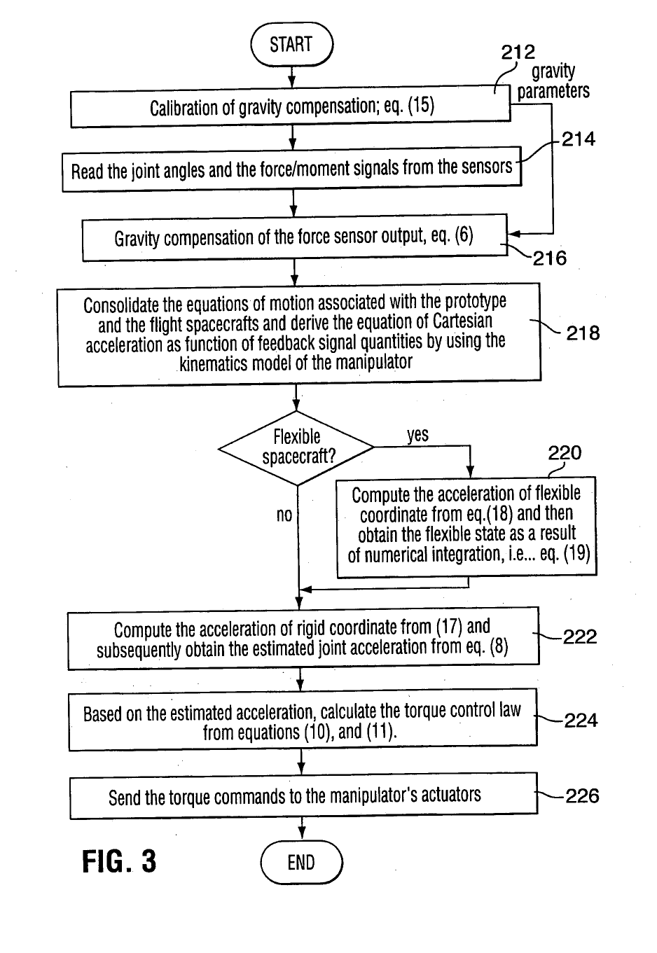

FIG. 3 is a flowchart showing a method of emulating a zero-gravity environment according to another embodiment of the present invention. This method explicitly includes steps relating to such emulation in the case where the flight-spacecraft has flexible elements. The method can be used for emulating a zero-gravity environment for a ground-spacecraft having sensors and actuators on-board. The ground-spacecraft is placed in an emulation system having a force/moment sensor and a manipulator. The manipulator has a plurality of joints and a plurality of manipulator joint sensors attached to the plurality of joints. The emulation system also includes a control system. The method includes steps as illustrated in FIG. 3. Various ones of these steps will be described in further detail later in the description.

Step 212 performs a calibration of a gravity compensation procedure, to be used later. In a particular embodiment, an off-line calibration procedure is called to extract gravity parameters of the ground-spacecraft and the force/moment sensor offset. The remaining steps can preferably be called online by a computer control algorithm. In step 214, the control system receives a feedback signal having a generalized force component and a motion component, for example from joint sensors and the force/moment sensor. In step 216, the gravitational force component is removed from the force/moment signal based on the gravity parameters obtained in step 212. In step 218, the equation of the generalized acceleration of the spacecraft is derived as a function of quantities of the feedback signals, i.e. joint angles, velocities and the wrist force/moment, by subtracting the equations of motion associated with the ground-spacecraft and the flight-spacecraft, by use of kinematics mapping of the manipulator. In step 220, the equations of accelerations of the rigid coordinate and the flexible coordinate are decoupled. Subsequently, the flexural acceleration is computed and the flexural states are obtained as a result of numerical integration (note that step 220 is skipped if the flight-spacecraft is rigid). In step 222, the acceleration of the rigid coordinate is computed based on the feedback signal and the value of the flexural states. Subsequently, the joint acceleration is estimated using a manipulator kinematics model, which can be determined based on geometric parameters of the manipulator, as known to those of ordinary skill in the art. In step 224, the vector of joint torques are computed based on the dynamics model of the manipulator such that the manipulator produces the desired joint acceleration. Finally, in step 226, the controller issues the joint torque command(s) to the manipulator's actuators. Steps 214 to 226 are iterated as long as it is necessary to emulate the 0-G environment. Such iteration of the steps, as illustrated in FIG. 3, can be performed, for example, in a computer program.

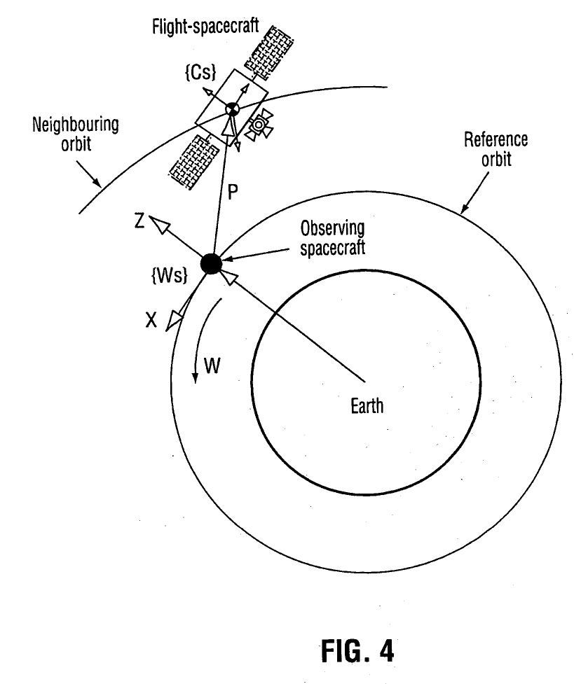

In order to discuss the operation of the control system 108, particularly in relation to the method described briefly above, it is beneficial to consider a dynamics model that takes into account the dynamics of a rigid spacecraft. The dynamic motion of a flight-spacecraft can be expressed in reference {Wₛ} which can be either: an inertial frame, or a moving frame attached to a virtual observing spacecraft in neighbouring orbit. The former leads to a simple dynamics formulation and is particularly useful when the spacecraft is considered purely as a free-flying object. The latter, however, leads to a more accurate dynamics formulation by taking the effect of orbital dynamics into account. Choosing the moving frame is suitable for emulation of a flight-spacecraft in a satellite rendezvous or docking operation, where the motion of the target spacecraft is preferably expressed relative to another spacecraft in a neighbouring orbit. FIG. 4 is a schematic of the flight-spacecraft showing its relative position and orientation in two neighbouring orbits. 3. The ground-spacecraft can emulate the motion dynamics of the flight-spacecraft with respect to another spacecraft in neighbouring orbit. This is useful for ground-testing space systems involving more that one spacecraft, e.g., constellation satellite, rendezvous satellite, and docking satellite.

Case(i): {Wₛ} is an inertial frame. The body-fixed frame {Cₛ} is chosen to be coincident with the center of mass (CM). Assume that the orientation of the body-fixed frame {Cₛ} with respect to the fixed frame {Wₛ} is represented by the rotation matrix R. In the following, all quantities are expressed in the coordinate frame {Ws}, unless otherwise is specified. Let ƒₐ^{T}=[Fₐ^{T} nₐ^{T}] denote the components of the control force Fₐ and moment nₐ, due to the spacecraft actuators, e.g. thrusters or reaction wheels, which act on the spacecraft CM and are expressed in frame {Ws}. Also, consider the generalized velocity vector νₛ^{T}=[νₛ^{T} ωₛ^{T}] containing the components of the linear velocity v and angular velocity ω of the spacecraft CM expressed in the coordinate {Wₛ}. Assume that mₛ and ^{C}Iₛ denote the spacecraft mass and inertia tensor expressed in the body-fixed frame {Cₛ}, respectively. Then, the linear and angular spacecraft dynamics can be concisely written as

$${M}_{s} {\dot{v}}_{s} + {h}_{s} ( {v}_{s} ) = {f}_{a} \\ where \\ {M}_{s} = [ \begin{matrix}{m}_{s} \underline{1} & 0 \\ 0 & {I}_{s}\end{matrix} ] , {h}_{s} = [ \begin{matrix}0 \\ {ω}_{s} \times {I}_{s} {ω}_{s}\end{matrix} ] \qquad ( 1 a )$$

and Iₛ=R^{C}IₛR^{T} denotes the inertia tensor expressed in the coordinate frame {Wₛ}, and 1 denotes the 3×3 identity matrix. Equation (1a) describes dynamics of a rigid-body spacecraft in the reference frame {Ws}, which is an inertial frame.

Case (ii): the coordinate system {Wₛ} is not inertial. Rather, the origin of the coordinate frame is fixed at centre of an observing satellite and is moving with it. The dynamics of the spacecraft in an orbit can be expressed by the Euler-Hill equations, which describe the relative translational motion of the spacecraft. In this formulation, the evolution of the translational motion of the spacecraft is observed from another spacecraft in neighbouring orbit. FIG. 4 illustrates relative position and orientation of the flight-space in two neighbouring orbits. Assume that the reference orbit is circular and that the x-axis and z-axis of the coordinate frame {Ws} are aligned with the tangential and the normal directions, respectively, as illustrated in FIG. 4. Then the equations of translational motion of the spacecraft in the moving frame {Wₛ} can be described by
mₛ(\dot{ν}ₛ−2ω₀×νₛ+Lρ)=Fₐ
Here ω₀=[0 w 0]^{T}, w is the constant angular velocity of the reference orbit, L=diag{0, w²,−3w²}, and

$$ρ = {\int }_{0}^{t} {v}_{s} ⅆ t + {ρ}_{0} .$$

The equations of rotational motion of the flight-spacecraft in the moving frame {Ws} can be written as
Iₛ\dot{ω}ₛ+Iₛ(ω₀×ωₛ)+(ωₛ+ω₀)×Iₛ(ωₛ+ω₀)=nₐ
The above equations can be written in this compact form

$${M}_{s} {\dot{v}}_{s} + {h}_{s} ( {v}_{s} ) + {y}_{s} ( {v}_{s} , {ω}_{0} ) = {f}_{a} \\ where \\ {y}_{s} = [ \begin{matrix}{m}_{s} ( - 2 {ω}_{0} \times {v}_{s} + L ρ ) \\ {I}_{s} ( {ω}_{0} \times {ω}_{s} ) + ( {ω}_{s} + {ω}_{0} ) \times {I}_{s} {ω}_{0}\end{matrix} ] . \qquad ( 1 b )$$

Note that since y(νₛ,ω₀)|_{ω}_{₀}₌₀=0, equation (1a) is a special case of equation (1b). Therefore, in the following, (1b) is considered.

The ground-spacecraft 104 handled by a manipulator 102 is illustrated in FIG. 1. The fixed coordinate frame {W} is located at an arbitrary location, such as at the robot base, and the z-axis is parallel to the gravity vector. Analogously, the origin of body-fixed frame {C} is chosen to be coincident with the CM of the ground-spacecraft. The orientation of frame {C} with respect to {W} is represented by rotation matrix R. Assume that mₘ and ^{C}Iₘ are the mass and inertia of the ground-spacecraft that differ from that of the flight-spacecraft. Also assume that a force/moment sensor 106 is installed in the mechanical interface of the end-effector of manipulator system 102, and that the ground-spacecraft system can measure the generalized force/moment interaction between the two systems. Consider the ground-spacecraft as a system separated from the manipulator at the location of the force sensor 106. Then, the ground satellite is exposed to three different forces: the actuation force, gravitational force ƒ_{g}, and force interaction between the ground-spacecraft and manipulator ^{S}ƒₛ which can be measured by the sensor. Note that ^{S}ƒₛ is expressed in the body-fixed coordinate {S} which is coincident with the sensor coordinate and is parallel to {C}. However, f_{g} acts on the CM and is expressed in the coordinate {W}.

Since the z-axis of frame {W} is parallel to the earth gravity vector g, as illustrated in FIG. 1, then the gravity force can be expressed as

$${f}_{g} = [ \begin{matrix}{m}_{m} g \\ 0\end{matrix} ] where {g}^{T} = [ \begin{matrix}0 & 0 & - 9.81\end{matrix} ] .$$

Analogous to (1), the dynamics of the ground spacecraft 104 can be described by

$${M}_{m} \dot{v} + {h}_{m} ( v ) = - {T}^{S} {f}_{s} + {f}_{g} + {f}_{a} , \\ {M}_{m} = [ \begin{matrix}{m}_{m} 1 & 0 \\ 0 & {I}_{m}\end{matrix} ] , {h}_{m} = [ \begin{matrix}0 \\ ω \times {I}_{m} ω\end{matrix} ] \qquad ( 2 )$$

where Iₘ=R^{C}IₘR^{T}, and T denotes the transformation from coordinate {S} to {W}. Also the negative sign of ƒₛ in equation (2) is due to the fact that the reaction force is seen by the sensor 106 in the opposite direction. Without loss of generality, we assume parallel coordinates, i.e.

$$T = [ \begin{matrix}R & 0 \\ - R [ c \times ] & R\end{matrix} ] , where [ c \times ] = [ \begin{matrix}0 & - {c}_{z} & {c}_{y} \\ {c}_{z} & 0 & - {c}_{x} \\ - {c}_{y} & {c}_{x} & 0\end{matrix} ]$$

In the above, vector c=[cₓ c_{y} c_{z}]^{T} denotes the origin of {C} with respect to {S}.

Assume the following two conditions: both ground and flight spacecrafts experience the same actuation force ƒₐ; and they have equal generalized velocity, i.e., ν=νₛ. Then, the ground-spacecraft is dynamically equivalent to the flight-spacecraft if they produce identical acceleration, i.e., \dot{ν}=\dot{ν}ₛ, under the above conditions. However, the accelerations are governed by two different equations of motion of the spacecrafts, and hence in general \dot{ν}≠\dot{ν}ₛ.

A discussion of the control considerations involved in embodiments of the present invention now follows. Let \dot{\hat{ν}} represent an estimation of acceleration of the two spacecrafts that can be obtained by subtracting equation (2) from (1b), that is,

$$\begin{matrix}{M}_{Δ} \dot{\hat{v}} + {h}_{Δ} + {y}_{s} = {f}_{s}^{′} \\ where & ( 3 ) \\ {M}_{Δ} = [ \begin{matrix}( {m}_{s} - {m}_{m} ) \underline{1} & 0 \\ 0 & {I}_{s} - {I}_{m}\end{matrix} ] , and & ( 4 ) \\ {h}_{Δ} = [ \begin{matrix}0 \\ ω \times ( {I}_{s} - {I}_{m} ) ω\end{matrix} ] , & ( 5 ) \\ {f}_{s}^{′} = {T}^{S} {f}_{s} - {f}_{g} & ( 6 )\end{matrix}$$

Note that here we emulate the motion dynamics of the flight-spacecraft as seen in another spacecraft in a neighbouring orbit. To emulate the motion dynamics of the flight-spacecraft in free space one should subtract equation (2) from (1a) and that results in equation (3) where the term yₛ is removed.

The actual acceleration might be different from the estimated \dot{ν}=\hat{\dot{ν}}−\hat{\dot{ν}}, \dot{ν}ₛ=\hat{\dot{ν}}+\hat{\dot{ν}}, and \hat{\dot{ν}} is the error on the estimation of the acceleration. Since \hat{\dot{ν}}=0 [symbol] \dot{ν}=\dot{ν}ₛ, the equations of motion of the two spacecraft are equivalent if \hat{\dot{ν}}≡0. Since the ground-spacecraft is rigidly attached to the manipulator's end-effector, they both share the same velocity and acceleration. Therefore, the estimated acceleration can be computed from the manipulator joint angles and velocities through its kinematics model. In the following, we first transform the estimated acceleration into joint acceleration, which constitutes the desired acceleration. Then, a torque-control law is developed to force the manipulator to deliver the requested acceleration.

The linear and angular velocities in equation (5) can be obtained from the joint velocities through the kinematic mapping of the manipulator. Let the vectors q, \dot{q}, and \ddot{q} contain the joint angles, velocities, and acceleration of the manipulator. Also, assume

$$J = [ \begin{matrix}{J}_{v} \\ {J}_{ω}\end{matrix} ]$$

represents the manipulator Jacobian written in fixed frame {C}, where submatrices Jᵥ J_{ω} denote the translational and rotational Jacobian, respectively. Note that the Jacobian is a determinant defined for a finite number of functions of the same number of variables in which each row consists of the first partial derivatives of the same function with respect to each of the variables. Then, we have
ν=J\dot{q}
and time-derivative of the above equation leads to
\dot{ν}=J\ddot{q}+\dot{J}\dot{q} (7)
Now assume that \dot{\hat{ν}} is an estimation of acceleration computed from equation (3); note that \dot{\hat{v}} is not necessarily equal to the actual acceleration \dot{v}. Then substituting \hat{\dot{v}} into (7) gives the estimation of joint acceleration as

$$\begin{matrix}\ddot{\hat{q}} = {J}^{- 1} ( \dot{\hat{v}} - \dot{J \dot{q}} ) \\ = {J}^{- 1} {M}_{Δ}^{- 1} ( {f}_{s}^{′} - {h}_{Δ} - {y}_{s} ) - {J}^{- 1} \dot{J \dot{q}} .\end{matrix} \qquad ( 8 )$$

in the above equation M_{Δ}⁻¹(q) can be calculated in terms of the manipulator's joint angles as

$${M}_{Δ}^{- 1} ( q ) = [ \begin{matrix}{( {m}_{s} - {m}_{m} )}^{- 1} \underline{1} & 0 \\ 0 & {( {I}_{s} - {I}_{m} )}^{- 1}\end{matrix} ] , \\ {where \\ ( {I}_{s} - {I}_{m} )}^{- 1} = R ( q ) {( {}_{}^{C}{I}{}_{s}^{} - {}_{}^{C}{I}{}_{m}^{} )}^{- 1} {R}^{T} ( q ) .$$

Moreover, since ν(q,\dot{q})=J_{ν}\dot{q} and ω(q,\dot{q})=J_{ω}\dot{q}, we can compute h_{Δ}(q,\dot{q}) and yₛ(q,\dot{q}) in terms of the joint angles and velocities. Finally, the desired joint acceleration can be computed from the following equation

$${q}^{\ddot{\hat{}}} = - {J}^{- 1} \dot{J} \dot{q} + {J}^{- 1} [ \begin{matrix}{( {m}_{s} - {m}_{m} )}^{- 1} {F}_{s}^{′} \\ {( {I}_{s} - {I}_{m} )}^{- 1} {n}_{s}^{′}\end{matrix} ] - \\ {J}^{- 1} [ \begin{matrix}0 \\ {( {I}_{s} - {I}_{m} )}^{- 1} ( {J}_{ω} \dot{q} \times ( {I}_{s} - {I}_{m} ) {J}_{ω} \dot{q} )\end{matrix} ] - \\ {J}^{- 1} [ \begin{matrix}\frac{{m}_{s}}{{m}_{s} - {m}_{m}} ( - 2 {ω}_{0} \times {J}_{v} \dot{q} + L ρ ) \\ {( {I}_{s} - {I}_{m} )}^{- 1} [ {I}_{s} ( {ω}_{0} \times {J}_{ω} \dot{q} ) + ( {ω}_{0} + {J}_{ω} \dot{q} ) \times {I}_{s} {ω}_{0} ]\end{matrix} ]$$

where p(q) is calculated from the forward kinematics of the manipulator; F′ₛ and n′ₛ are the force and moment components of ƒ′ₛ. Note that the estimated acceleration is bounded only if mₛ≠mₘ and ^{C}Iₛ≠^{C}Iₘ.

The joint acceleration (8) is called predicted joint acceleration, which constitutes the desired joint acceleration. Therefore, in an embodiment of the present invention, it is the goal of the control system 108 to track the desired acceleration trajectory. This can be achieved by using an inverse-dynamics control scheme which incorporates the dynamics model of the manipulator. Therefore, it is desirable to use measurements relating to the joints, such as joint angle, joint trajectory, and joint acceleration, as a particular parameter in relation to which inertia can be calculated. If it is assumed that the manipulator is rigid, the dynamics of the manipulator can be described by
Mᵣ\ddot{q}+hᵣ(q,\dot{q})+gᵣ(q)=τ+J^{T}Tfₛ (9)
where Mᵣ represents inertia of the manipulator, the nonlinear vector hᵣ contains Coriolis and centrifugal terms, gᵣ is the torque due to gravity of linkage, and τ is the vector of generalized joint torque. To be consistent with equation (3), equation (9) should be represented in terms of f′ₛ instead of fₛ. This can be achieved if the gravitational term gᵣ in (9) is replaced by gᵣₘ=gᵣ−mₘJᵥ^{T}Rg. It is worthwhile pointing out that gᵣₘ represents gravitational torque due to the manipulator's link and the payload combined.

Now, consider the following control law
τ=Mᵣu+hᵣ+gᵣₘ−J^{T}f′ₛ (10)
where u is the auxiliary control input
u=\hat{\ddot{q}}+G_{D}(∫\hat{\ddot{q}}dt−\dot{q})+G_{P}(∫∫\hat{\ddot{q}}dt−q) (11)
Assume \tilde{q}=\hat{q}−q, where \hat{q} is obtained as a result of consecutive integration of \hat{\ddot{q}}, then the error dynamics can be represented as \tilde{\ddot{q}}+G_{D}\tilde{\dot{q}}+G_{P}\tilde{q}=0. The error is asymptotically stable if the gain parameters are adequately chosen, i.e. q, \tilde{\dot{q}}, \tilde{\ddot{q}}→0 as t→∞, or \ddot{q}→\hat{\ddot{q}} as t→∞ if G_{P}, G_{D}>0. Denoting \tilde{\dot{ν}}=\hat{\dot{ν}}−\dot{ν} we have \hat{\dot{ν}}−\dot{ν}=J(\hat{\ddot{q}}−\ddot{q}), or
∥\tilde{\dot{ν}}∥≦κ∥\tilde{\ddot{q}}∥,
where κ<∞ is the maximum singular value of the Jacobian over all configurations and ∥·∥ stands for the Euclidean norm of a vector. The right-hand-side of the above inequality approaches zero and hence so does the left-hand-side, i.e. \hat{\dot{ν}}→\dot{ν} as t→∞.

Introducing the acceleration error is tantamount to a force error \tilde{ƒ}ₐ that enters in the dynamics model of the emulated flight-spacecraft. That is
Mₛ\dot{ν}+hₛ(ν)=ƒₐ−\tilde{ƒ}ₐ
where \tilde{ƒ}ₐ=M_{Δ}\tilde{\dot{ν}}. Since M_{Δ} is a bounded matrix, \hat{\dot{ν}}→0 implies that \tilde{ƒ}ₐ→0. Therefore, the dynamics of the ground-spacecraft and the flight-spacecraft are equivalent under the above control law.

Ideally, the ground-spacecraft inertial properties can be scaled at will, regardless of the scale of the manipulator. However, there is a practical issue which should be considered in the design. Assuming a steady-state mode where control error reaches zero, i.e. e=\dot{e}=0, the torque control input can be grouped into a force feedback term and a motion feedback term O(q,\dot{q}) as

$$τ = {J}^{T} \underbrace{( {M}_{cr} {( {M}_{s} - {M}_{m} )}^{- 1} - {1}_{\underline{\_}} )}_{a} {f}_{s}^{′} + O ( q , \dot{q} ) \qquad ( 12 )$$

where M_{cr}=J^{-T}MᵣJ⁻¹ is the Cartesian inertia of the manipulator, 1 is a 6×6 identity matrix, and O(q,\dot{q})=J⁻¹\dot{J}\dot{q}+hᵣ(q,\dot{q})+gᵣ′(q)−J^{T}M_{cr}M_{Δ}⁻¹h_{Δ}(q,\dot{q}) is the portion of the torque controller law which solely depends on motion. Note that α can be treated as the force feedback gain. In the following we examine two extreme cases of α.

Consider a case where α→∞. In such a case, it is evident from (12) that the control torque input is unbounded if M_{Δ} is a singular matrix. That is, the proposed feedback law is feasible only if the ground-spacecraft and the flight-spacecraft do not have identical mass or rotation inertia, i.e. mₛ≠mₘ and Iₛ≠Iₘ. At first glance, this result seems counterintuitive. But, this fact can be also concluded from dynamics equations of the satellite and mockup. It can be inferred from (1) and (2) that if Mₘ=Mₛ [symbol] fₛ=T⁻¹ƒ_{g}. In that case the torque sensor signal contains no information about the external force ƒₐ whatsoever. In fact, the force interaction between the manipulator and the mockup exists only if their generalized movements in free-space result in different inertial forces.

Consider the case where α=0. In such a case, equation (12) implies that the force feedback is disabled if M_{cr}=M_{Δ}. That is
M_{cr}+Mₘ=Mₛ [symbol] α=0 (13)
This is interesting because, then the emulation can be implemented without force feedback. However, the condition in (13) cannot be realized physically, because Mₘ and Mₛ are constant matrices while the robot inertia M_{cr}(q) is configuration dependent. Yet, (13) may suggest that the force feedback gain can be minimized if the collective inertia of the manipulator and the mockup is selected to be close to the satellite inertia.

In practice, the fidelity of the emulation system is adversely affected by disturbance and sensor noise. The effect of sensor noise is twofold: (i) the error \tilde{\dot{ν}}₁ of the estimated acceleration is introduced; and (ii) acceleration tracking error \tilde{\dot{ν}}₂ of the control system is introduced. The former can be calculated from (3). Assume vector εₙ denotes the additive sensor noise, i.e., the sensor reading is ^{S}fₛ+εₙ, then \tilde{\dot{ν}}₁=M_{Δ}⁻¹Tεₙ. The latter error is related to the disturbance sensitivity of the control system. The torque-control law (10) in presence of disturbance is τ=Mᵣu+hᵣ(q,\dot{q})+gᵣ′(q)−J^{T}(ƒₛ′+Tεₙ). Now substituting the above torque-control law into (9) yields Mᵣ(\tilde{\ddot{q}}+G_{D}\tilde{\dot{q}}+G_{P}\tilde{q})=J^{T}Tεₙ; the equation of the error is no longer homogenous. Assuming that Mᵣ and J are constant matrices and that the controller gains are G_{D}=2Ω and G_{P}=Ω², where Ω is the controller bandwidth, then we can say \tilde{\dot{ν}}₂=Z(s)M_{cr}⁻¹Tεₙ.

Here transfer function

$$Z ( s ) = \frac{{s}^{2}}{{( s + Ω )}^{2}}$$

represents admittance of the control system. Finally, the force error due to the overall acceleration error \tilde{\dot{ν}}=\tilde{\dot{ν}}₁+\tilde{\dot{ν}}₂ is
\tilde{ƒ}ₐ=(1+Z(s)(Mₛ−Mₘ)M_{cr}⁻¹)Tεₙ
Observe that

$$\vert Z ( j \underline{ω} ) \vert = \frac{{\underline{ω}}^{2}}{{\underline{ω}}^{2} + {Ω}^{2}} ,$$

In other words, the transfer function of the admittance behaves as a high-pass filter and it can filter out noise and disturbance at low frequencies, i.e., |Z(jω)|≈0 for ω<<Ω (note that ω here denotes the frequency and it should not be confused with the angular velocity). Hence, a controller which has sufficiently high bandwidth is able to reject the effect of sensor noise and disturbance.

One of the main challenges of control implementation is the fact that the force/moment sensor signal contains values of the external force superimposed with those of gravitational and inertial forces of the prototype satellite. The inertial force is compensated within the feedback loop. But, the gravitational force enters as an external disturbance to the feedback loop and also contributes a significant component in the sensor output signal.

Therefore, in a particular embodiment, the gravitational force must be precisely estimated and then subtracted from the force sensor reading. A complete compensation requires continuous measurement of the orientation of the manipulator end-effector with respect to the gravity vector in addition to the values of the mass and the center of mass of the mockup satellite as well as the force sensor offset. To explain further, the sensor outputs signals proportional to the force, but each sensor usually suffers from an offset, f₀. It is generally only necessary to know the center of mass of the mockup, as the center of mass of the manipulator changes as the manipulator moves.

To this end, a calibration procedure has been developed to extract the required parameters for modelling of the gravitational force. A sequence of sensor readings are recorded by locating the manipulator in different known poses, or positions. Then, the parameters are identified by a conventional least-squares algorithm.

In the following we assume a static case where \dot{q}=\ddot{q}=0. Hence, the sensor output coincides with the gravity of the ground-spacecraft. If the gravity is completely compensated, then for every pose or position, ƒ′ₛ=0. This requires that T(^{S}ƒₛ−ƒ₀)−ƒ_{g}=0, where f₀^{T}=[F₀^{T} n₀^{T}] denotes the sensor offset. Hence, we have ^{S}ƒₛ=T⁻¹ƒ_{g}+ƒ₀ which can be written in the linear regression form

$${}_{}^{s}{f}{}_{s}^{} = \underbrace{[ \begin{matrix}\underline{1} & ϕ & 0 & 0 \\ 0 & 0 & \underline{1} & - [ ϕ \times ]\end{matrix} ]}_{Φ} \underbrace{[ \begin{matrix}{F}_{0} \\ m \\ {n}_{0} \\ mc\end{matrix} ]}_{Θ} = Φ Θ$$

where φ(q)=R^{T}(q)g. In the above equation Φ is the regressor, and vector Θ contains the parameters of interest. Assume that a sequence of measurements of the sensor output [^{S}ƒₛ₁,^{S}ƒₛ₂, . . . ,^{S}ƒₛₙ]^{T} is obtained when the manipulator is positioned at n different positions [q₁,q₂, . . . ,qₙ]^{T}, where \dot{q}ᵢ=\ddot{q}ᵢ=0. Also, let Φᵢ(qᵢ) be the corresponding regressor obtained at the i-th position qᵢ. Then, we have

$$[ \begin{matrix}{}_{}^{s}{f}{}_{s1}^{} \\ ⋮ \\ {}_{}^{s}{f}{}_{sn}^{}\end{matrix} ] = [ \begin{matrix}{Φ}_{1} \\ ⋮ \\ {Φ}_{n}\end{matrix} ] Θ \qquad ( 14 )$$

which can be written in the compact form Y=ΦₐΘ. Assuming sufficient independent equations in (14), one can obtain the set of estimated parameters \hat{Θ} by the least squares method as
\hat{Θ}=Φₐ⁺Y, (15)
where Φₐ⁺=Φₐ^{T}(ΦₐΦₐ^{T})⁻¹ is the pseudoinverse of the matrix Φ. Finally, the gravitational force can be compensated from the sensor output based on the estimated parameters by ƒ′ₛ=^{S}ƒₛ−Φ(q)\hat{Θ}.

Alternatively, an estimation of the parameters can be obtained recursively from the recursive least squares algorithm which works in two steps as follow

Step (i): gain update
Kₙ=(1+ΦₙPₙ₋₁Φₙ^{T})⁻¹Pₙ₋₁Φₙ^{T}
Pₙ=(1−KₙΦₙ)Pₙ₋₁
Step(ii): parameter update
ƒ′ₛₙ=^{S}ƒₛₙ−Φₙ\hat{Θ}ₙ₋₁
\hat{Θ}ₙ=\hat{Θ}ₙ₋₁Kₙƒ′ₛₙ
where P₀>γ1 and γ>0.

Many spacecraft, such as satellites, have flexible elements, such as solar panels, which can significantly affect the system dynamics. However, testing a flexible ground-spacecraft in a 1-G environment poses many difficulties due to large deformation induced by gravity. Indeed, the structure of a solar panel cannot even hold itself against gravity when it is fully deployed. In the following discussion, we extend the emulation concept for the case where the ground spacecraft is a rigid system while the target flight-spacecraft is a flexible system. It is assumed that the actuators are stowed to the rigid part of the ground spacecraft, which is attached to the emulating manipulator. The ground spacecraft lacks any flexible hardware, such as the solar panels. Yet, the motion perturbation caused by the flexible dynamics is generated by a simulation and the subsequent signals are superimposed on the motion of the rigid ground-spacecraft.

Let ξ denote the flexural coordinate of a flexible spacecraft. Also assume that the actuators are placed in the rigid part of the spacecraft. Then, the equations of motion of the entire system can be written in the partitioned mass matrix form

$$[ \begin{matrix}{M}_{s} & {M}_{sf} \\ {M}_{sf}^{T} & {M}_{f}\end{matrix} ] [ \begin{matrix}\dot{v} \\ \ddot{ξ}\end{matrix} ] + [ \begin{matrix}{h}_{s1} ( v , ξ , \dot{ξ} ) \\ K ξ + {\overline{h}}_{f} ( v , ξ , \dot{ξ} )\end{matrix} ] = [ \begin{matrix}{f}_{a} \\ 0\end{matrix} ] \qquad ( 16 )$$

where M_{ƒ} is the flexural inertia matrix, M_{sƒ} is the cross inertia matrix, K is the generalized stiffness matrix; and hₛ₁ and \overline{h}_{ƒ} are the nonlinear vectors associated with the rigid and flexural coordinates. Analogous to the case of rigid spacecraft, subtracting equation (16) from (1) gives

$$[ \begin{matrix}{M}_{Δ} & {M}_{sf} \\ {M}_{sf}^{T} & {M}_{f}\end{matrix} ] [ \begin{matrix}\dot{v} \\ \ddot{ξ}\end{matrix} ] + [ \begin{matrix}{h}_{Δ 1} \\ {h}_{f}\end{matrix} ] = [ \begin{matrix}{f}_{s}^{′} \\ 0\end{matrix} ] ,$$

where h_{Δ1}=hₛ₁−hₘ and h_{ƒ}=h_{ƒ}+Kξ. Define the Schur complement of M_{ƒ} as
M_{Δ1}=M_{Δ}−M_{sƒ}M_{ƒ}⁻¹M_{sƒ}^{T}
Then the rigid and flexural acceleration can be found through inversion of the partitioned mass matrix as
M_{Δ1}\dot{ν}=ƒ′ₛ−h_{Δ1}−h_{ƒ2} (17)
M_{ƒ}\ddot{ξ}=−hₛ₂−M_{sƒ}^{T}M_{Δ1}⁻¹(ƒₛ′−h_{Δ1}+h_{ƒ2}) (18)
where h_{ƒ2}=M_{sƒ}M_{ƒ}⁻¹h_{ƒ}; and the inertia matrices M_{Δ1} and M_{f} are always invertible.

Equations (17) and (18) constitute the acceleration models of the rigid coordinate and the flexural coordinate in a decoupled form. Now, substituting the acceleration of the rigid coordinate from (17) into (8) and transforming the Cartesian velocities into the joint velocities yields an estimation of the acceleration of the manipulator's joints
\hat{\ddot{q}}(q,\dot{q},ξ,\dot{ξ},ƒ′ₛ)=−J⁻¹\dot{J}\dot{q}+J⁻¹M_{Δ1}⁻¹(ƒₛ′−h_{Δ1}−yₛ−h_{ƒ2}), (19)
which in turn, can be plugged into (11) and (12) to obtain the control law. However, to calculate the acceleration from (17) requires the value of the flexible state because hₛ₁ and h_{ƒ} are functions of ξ and \dot{ξ}. The flexural state cannot be measured but can be obtained by simulation. To this end, the acceleration of the flexural coordinate can be computed from
\ddot{ξ}(q,\dot{q},ξ,\dot{ξ},ƒ′ₛ)=M_{ƒ}⁻¹(−hₛ₂−M_{sƒ}^{T}M_{Δ1}⁻¹(ƒₛ′−h_{Δ1}+h_{ƒ2})), (20)
that can be used to obtain the flexural states as a result of numerical integration, i.e.,

$$[ \begin{matrix}ξ \\ \dot{ξ}\end{matrix} ] = \int [ \begin{matrix}ξ \\ \ddot{ξ}\end{matrix} ] ⅆ t \qquad ( 21 )$$

To summarize, the emulation of flexible spacecraft proceeds as the following steps: (i) start at a time when all of the system states, i.e. {q,\dot{q},ξ,\dot{ξ}}, are known; (ii) apply control law (10) and (11) to the manipulator; (iii) obtain the flexural states as a result of numerical integration of (18) and then go to step (ii).

In other words, methods according to embodiments of the present invention can be described as follows. In an aspect, the present invention provides a method of emulating a zero-gravity (0-G) environment for a ground-spacecraft that emulates a flight-spacecraft in three dimensions. The ground-spacecraft is placed in an emulation system including a manipulator having a plurality of joints, and a control system. The method includes the following steps: receiving, at the control system, a feedback signal having a generalized force component and a motion component; removing components of gravitational force from the generalized force component; determining a desired trajectory of the manipulator based on the received feedback signal, on parameters of a dynamics model of the ground-spacecraft, and on parameters of a dynamics model of the flight-spacecraft; calculating a desired control command to be applied to the manipulator based on the determined desired trajectory; and issuing a control command to the manipulator in order to achieve ground-spacecraft dynamic motion corresponding substantially to a desired dynamic motion of the flight-spacecraft in 0-G.

The step of determining the desired trajectory of the manipulator can include replicating dynamic motion of a flight-spacecraft described in one of an inertial frame or a moving frame attached to an observing satellite in neighbouring orbit. The step of determining the desired trajectory of the manipulator can include emulating, at the ground-spacecraft, the motion dynamics of the flight-spacecraft with respect to another spacecraft in neighbouring orbit. The step of removing components of gravitational force from the generalized force component can include compensating the force/moment sensor signals for the gravity of the ground-spacecraft. The parameters of the dynamics model of the ground-spacecraft are selected from the group consisting of mass and inertia. The parameters of the dynamics model of the flight-spacecraft are selected from the group consisting of inertia, mass, stiffness, and damping.

The ground-spacecraft can have components in a flexural coordinate and a rigid coordinate. In that case, the step of determining desired trajectory of the manipulator can include the steps of: removing components due to unknown actuation forces; decoupling the equations of acceleration of the flexural coordinates and rigid coordinates; and deriving the equation of the desired joint-acceleration as functions of joint quantities by making use of manipulator kinematics mapping. The step of removing components due to unknown actuation forces can include: subtracting equations of motion of the ground-spacecraft from equations of motion of the flight-spacecraft. The step of decoupling the equations of acceleration of the flexible coordinate and rigid coordinate can include the steps of: calculating acceleration of the flexible coordinate based on the feedback signal; and obtaining the flexible state as a result of numerical integration of the acceleration. The step of decoupling the equations of acceleration of the flexible coordinate and rigid coordinate can include the step of: using equations of acceleration of the rigid coordinate and manipulator kinematics to calculate estimated joint acceleration of the manipulator.

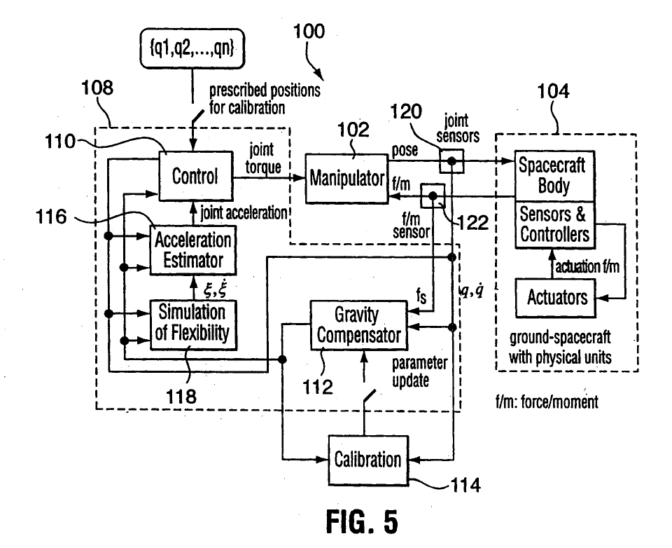

FIG. 5 is a block diagram illustrating an emulation system incorporating a control system according to an embodiment of the present invention. The emulation system 100 includes the manipulator 102 and the testing ground-spacecraft 104 as previously discussed. In FIG. 5, the ground-spacecraft 104 is a rigid spacecraft having a complete motion control system including physical actuator and sensor units and controller. The manipulator 102 acts on the ground-spacecraft 104 in response to information received from the control system 108 in order to bring it into a particular position, or pose. The manipulator 108 can also receive information from the joint sensors 120 and the wrist force/moment sensor 122. Such sensory information can be used to establish a dynamic motion characterized by the inertial parameters of a flight-spacecraft.

Also shown in FIG. 5 is a representation of control system 108, including a non-linear controller 110, joint acceleration estimator 116, flexible state simulator 118, and a gravity estimator 112. The controller 110 issues torque commands to the manipulator 102 in order to bring dynamics of ground-spacecraft combined with the manipulator in line with desired dynamics of a flight-spacecraft. The torque commands are preferably issued in response to the estimated acceleration information determined based on the principles and equations discussed in detail above.

The emulation system is able to add the dynamic motion induced by flexible elements, such solar panels, even though the test ground-spacecraft is rigid, i.e. it lacks any flexible element. This is achieved by incorporating a dynamic simulator 118 into the control system. The dynamic simulator can be advantageously implemented in software. In a particular embodiment, the dynamic simulator first computes the acceleration of the flexural states based on a decoupled derivation of the dynamics model of the flexibility. Then the flexural states are obtained as a result of numerical integration of the acceleration. The simulation can be based a derived model, and the acceleration can be calculated based on feedback, such as signals from the joint/force sensors and signals from joint angles and velocities.

Of course, if a target satellite to be simulated is strictly rigid and has no flexible parts, then the flexible state simulator 118 is not needed in the system. However, the flexible state simulator can advantageously be used to model behavior that does not necessarily relate to a flexible element or component. For instance, the perturbation dynamics caused by oscillatory movement of a flexible antenna or solar panel of a satellite can be produced by incorporating models of the flexible elements. As such, since it can be modeled, the associated perturbation can be emulated. Other examples of behavior that can be modeled as a perturbation are gravity gradient and drag due to atmosphere (imperfect orbit). As long as the perturbation can be modeled, it can be added to the acceleration estimator. The accuracy of emulation of the perturbation is generally affected by the accuracy of the perturbation model that is used.

A means for calibration is preferably provided, since calibration is typically needed right before emulating the motion of a spacecraft. The emulation model is very sensitive and could be affected by a change in center of mass caused by any minor adjustment prior to emulation. Therefore, in an embodiment, the control system preferably includes a calibration means, or calibrator, 114, in conjunction with the gravity estimator 112. In such a case, the gravity estimator 112 is in communication with the control system 108 and the calibrator 114 and provides an estimation of the gravitational force, in accordance with the principles and equations outlined above, to the control system 108. In a calibration mode, the controller 110 receives prescribed positions for calibration, and acts as a regulator by forcing the robot to travel to the prescribed positions.

The appearance of a switch-type connection between the prescribed positions and the controller 110 in FIG. 5 illustrates that the parameters are only sent in calibration mode. A user specifies the prescribed positions, then data is obtained from the force sensors when the robot travels to those prescribed positions. Calibration parameters are then derived based on the data obtained from the force sensors. The calibrator 114 is shown in FIG. 5 as being connected by a switch-type connection to the gravity compensator 112, indicating that parameters are only updated in calibration mode, and are held when in emulation mode.

The ground based emulation system can produce motion dynamics of a flight-spacecraft with respect to another observation satellite in neighbouring orbit. This capability is useful for ground-testing of complex space operations involving more that one spacecraft. Examples are constellation satellite, rendezvous of satellites, and docking satellites.

The calibrator 114 executes an off-line calibration procedure, preferably stored in a memory either in the calibrator itself or elsewhere in the control system 110, to extract the required parameters for modelling of the gravitational force. A sequence of sensor readings are recorded by locating the manipulator 102 in different known poses, or positions. Then, the parameters are identified by a conventional least-squares algorithm. Alternatively, the estimation process can be performed on-line by utilizing the recursive least-squares algorithm.

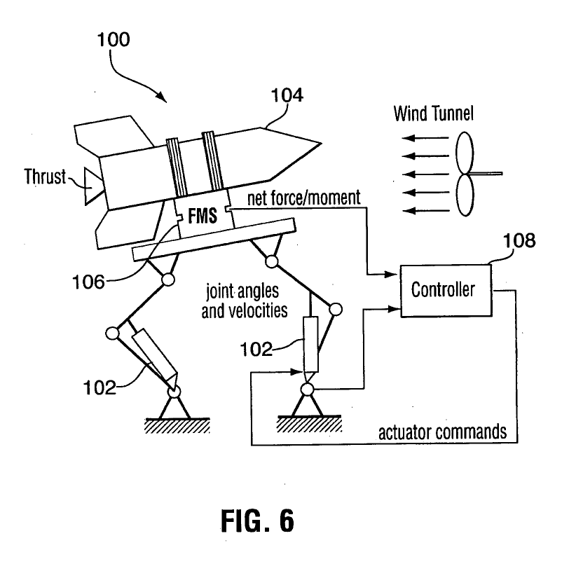

This emulation concept, although suitable for emulating spacecraft such as satellites, can be used for testing flight-spacecraft such as space vehicles or rockets. For instance, FIG. 6 is a diagrammatic representation of an emulation system incorporating a control system according to an embodiment of the present invention. The emulation system 100 of FIG. 6 shows the use of a parallel manipulator 102, e.g. the Steward Platform, that can carry the huge force/moment load of a space vehicle. For the cases of spacecraft and space vehicles, the entire hardware of the emulation system can be placed in a thermal-vacuum chamber mimicking a space-like vacuum and thermal condition. However, for the case of emulation of a ballistic rocket, as shown in FIG. 6, the emulation system 100 can be placed in an environment such as a wind tunnel in order to create a realistic aerodynamic condition.

In other words, in an aspect the present invention provides an emulation system which emulates a zero-gravity environment for testing in three-dimensions a ground-spacecraft having sensors and actuators on-board. The emulation system includes the following: a manipulator for manipulating the ground-spacecraft, the manipulator having a plurality of joints for receiving a motion component signal; a force/moment sensor in communication with the manipulator and the ground-spacecraft for receiving a generalized force component signal; and a control system for receiving and processing a feedback signal based on the received generalized force component signal and on the motion component signal and for controlling the dynamic behavior of the manipulator together with the ground-spacecraft based on the processed feedback signal in order to achieve ground-spacecraft dynamic motion corresponding to a desired dynamic motion of a flight-spacecraft in 0-G.

The manipulator can include a plurality of manipulator joint sensors attached to the plurality of joints. The control system can further include a flexible state simulator for simulating a flexible component of the flight-spacecraft. The control system can include means for removing components of gravitational force from the generalized force component signal. The control system can include means for determining a desired joint-acceleration trajectory of the manipulator based on the feedback signal, on parameters of a dynamics model of the ground-spacecraft, on parameters of a dynamics model of the flight-spacecraft, and on parameters of dynamics model of the manipulator. The control system ca include means for calculating a desired control command to be applied to the manipulator based on the determined desired trajectory. The control system can include means to issue a torque command to the manipulator to achieve the desired dynamic motion of a flight-spacecraft in 0-G. The force/moment sensor can be a six-axis force/moment sensor, and can be placed at the interface of the manipulator's end-effector and the ground-spacecraft. The manipulator can be a robotic manipulator, or a robotic arm having seven joints driven by electric motors.

In another aspect, the present invention provides a control system for use with an emulation system which emulates a zero-gravity environment for testing in three-dimensions a ground-spacecraft having sensors and actuators on-board. The emulation system includes a manipulator for manipulating the ground-spacecraft, the manipulator having a plurality of joints for receiving a motion component signal, and a force/moment sensor in communication with the manipulator and the ground-spacecraft for receiving a generalized force component signal. The control system includes: a receiver for receiving a feedback signal having components in three dimensions, the feedback signal being based on the generalized force component signal and the motion component signal; a processor for determining a desired trajectory of the manipulator based on the received feedback signal, on parameters of a dynamics model of the ground-spacecraft, and on parameters of a dynamics model of the flight-spacecraft, and for calculating a desired control command to be applied to the manipulator based on the determined desired trajectory; and a controller for controlling dynamic behavior of the ground-spacecraft so that dynamic motion of the ground-spacecraft corresponds substantially to the desired dynamic motion of the flight-spacecraft in 0-G.

The control system can further include a flexible state simulator for simulating a flexible component of the flight-spacecraft. The motion component signal can include information relating to the position and velocity of the joints. The controller can include means for controlling the dynamic behavior of the manipulator and the ground-spacecraft such that inertial parameters of the manipulator and the ground-spacecraft are combined so as to be substantially equivalent to desired target spacecraft inertial parameters. In such a case, the control system can further include means for customizing the desired target spacecraft inertial parameters. The control system can further include a computer-readable memory having recorded thereon sequences and instructions for execution by the controller to control the dynamic behavior of the ground-spacecraft so that dynamic motion of the ground-spacecraft corresponds substantially to the desired dynamic motion of the flight-spacecraft in 0-G.

The controller can include means for issuing torque commands to the manipulator to achieve the desired dynamic motion of the flight-spacecraft in 0-G. The controller can include means for issuing torque commands in response to manipulator joint angles and velocities measured at the joints. The control system can further include an estimator for performing one of: a computation of a gravitational force based on a measured attitude of an end effector of the manipulator; and an estimation of a gravitational force/moment of the ground-spacecraft on the six-axis force/moment sensor. The control system can further include means for determining the attitude by measuring manipulator joint angles. The control system can further include means for subtracting an estimated gravitational force from a received force feedback signal. The control system can further include a calibrator for performing one of: a measurement of the orientation of an end-effector of the manipulator with respect to the gravity vector, upon which measurements is based the estimated gravitational force/moment; and a measurement of values of mass and center of mass of the of the ground-spacecraft, upon which measurements is based the estimated gravitational force. The controller can be a non-linear controller.

Experimentally, motion dynamics of a 500 kg satellite were emulated using the robotic arm of the CSA Autonomous Robotics Testbed (CART). The arm had seven joints driven by electric motors. Only six joints were used in this experiment, i.e. one joint was locked. The robot was also equipped with a 6-axis force/moment sensor (from JR3, Inc.) mounted on the manipulator's end-effector where the ground-spacecraft (a mockup of the satellite) was mounted. Computer implementation of the control system was made possible by using the multi-processing platform OPAL-RT. The code was run under SIMULINK using the Real Time Workshop, while the sampling rate was set to 500 Hz. The experimental results demonstrated good tracking performance of the control system, as evidenced by the very similar trajectories of the requested or desired joint angles and the actual joint angles.

In summary, embodiments of the present invention provide an emulation system for use with a ground spacecraft that can test the spacecraft in three dimensions, in a 1-G environment, with real sensors and actuators in place. The system ensures that the collective inertia, or dynamic motion, of the manipulator and the ground-spacecraft is substantially equivalent to the desired inertia of the flight-spacecraft.

The above-described embodiments of the present invention are intended to be examples only. Alterations, modifications and variations may be effected to the particular embodiments by those of skill in the art without departing from the scope of the invention, which is defined solely by the claims appended hereto.

1. A method of emulating a zero-gravity (0-G) environment for a ground-spacecraft that emulates a flight-spacecraft in three dimensions, the ground-spacecraft being placed in an emulation system including a manipulator having a plurality of joints, and a control system, the method comprising:
receiving, at the control system, a feedback signal having a generalized force component and a motion component;
removing components of gravitational force from the generalized force component;
determining a desired trajectory of the manipulator based on the received feedback signal, on parameters of a dynamics model of the ground-spacecraft, and on parameters of a dynamics model of the flight-spacecraft;
calculating a desired control command to be applied to the manipulator based on the determined desired trajectory; and
issuing a control command to the manipulator in order to achieve ground-spacecraft dynamic motion corresponding substantially to a desired dynamic motion of the flight-spacecraft in 0-G.

2. The method of claim 1 wherein the step of determining the desired trajectory of the manipulator includes replicating dynamic motion of a flight-spacecraft described in one of an inertial frame or a moving frame attached to an observing satellite in neighbouring orbit.

3. The method of claim 2 wherein the step of determining the desired trajectory of the manipulator includes emulating, at the ground-spacecraft, the motion dynamics of the flight-spacecraft with respect to another spacecraft in neighbouring orbit.

4. The method of claim 1 wherein the step of removing components of gravitational force from the generalized force component comprises compensating the force/moment sensor signals for the gravity of the ground-spacecraft.

5. The method of claim 1 wherein the parameters of the dynamics model of the ground-spacecraft are selected from the group consisting of mass and inertia.

6. The method of claim 1 wherein the parameters of the dynamics model of the flight-spacecraft are selected from the group consisting of inertia, mass, stiffness, and damping.

7. The method of claim 1 wherein the ground-spacecraft has components in a flexural coordinate and a rigid coordinate, and the step of determining desired trajectory of the manipulator includes the steps of:
removing components due to unknown actuation forces;
decoupling the equations of acceleration of the flexural coordinates and rigid coordinates; and
deriving the equation of the desired joint-acceleration as functions of joint quantities by making use of manipulator kinematics mapping.

8. The method of claim 7 wherein the step of removing components due to unknown actuation forces includes: subtracting equations of motion of the ground-spacecraft from equations of motion of the flight-spacecraft.

9. The method of claim 7 wherein the step of decoupling the equations of acceleration of the flexible coordinate and rigid coordinate includes the steps of:
calculating acceleration of the flexible coordinate based on the feedback signal; and
obtaining the flexible state as a result of numerical integration of the acceleration.

10. The method of claim 7 wherein the step of decoupling the equations of acceleration of the flexible coordinate and rigid coordinate includes the step of:
using equations of acceleration of the rigid coordinate and manipulator kinematics to calculate estimated joint acceleration of the manipulator.

11. An emulation system which emulates a zero-gravity environment for testing in three-dimensions a ground-spacecraft having sensors and actuators on-board, the emulation system comprising:
a manipulator for manipulating the ground-spacecraft, the manipulator having a plurality of joints for receiving a motion component signal;
a force/moment sensor in communication with the manipulator and the ground-spacecraft for receiving a generalized force component signal; and
a control system for receiving and processing a feedback signal based on the received generalized force component signal and on the motion component signal and for controlling the dynamic behavior of the manipulator together with the ground-spacecraft based on the processed feedback signal in order to achieve ground-spacecraft dynamic motion corresponding to a desired dynamic motion of a flight-spacecraft in 0-G.

12. The emulation system of claim 11 wherein the manipulator includes a plurality of manipulator joint sensors attached to the plurality of joints.

13. The emulation system of claim 11 wherein the control system further comprises a flexible state simulator for simulating a flexible component of the flight-spacecraft.

14. The emulation system of claim 11 wherein the control system includes means for removing components of gravitational force from the generalized force component signal.

15. The emulation system of claim 11 wherein the control system includes means for determining a desired joint-acceleration trajectory of the manipulator based on the feedback signal, on parameters of a dynamics model of the ground-spacecraft, on parameters of a dynamics model of the flight-spacecraft, and on parameters of dynamics model of the manipulator.

16. The emulation system of claim 11 wherein the control system includes means for calculating a desired control command to be applied to the manipulator based on the determined desired trajectory.

17. The emulation system of claim 12 wherein the control system includes means to issue a torque command to the manipulator to achieve the desired dynamic motion of a flight-spacecraft in 0-G.

18. The emulation system of claim 11 wherein the force/moment sensor is a six-axis force/moment sensor.

19. The emulation system of claim 11 wherein the force/moment sensor is placed at the interface of the manipulator's end-effector and the ground-spacecraft.

20. The emulation system of claim 11 wherein the manipulator is selected from the group comprising: a robotic manipulator; and a robotic arm having seven joints driven by electric motors.

21. A control system for use with an emulation system which emulates a zero-gravity environment for testing in three-dimensions a ground-spacecraft having sensors and actuators on-board, the emulation system including a manipulator for manipulating the ground-spacecraft, the manipulator having a plurality of joints for receiving a motion component signal, and a force/moment sensor in communication with the manipulator and the ground-spacecraft for receiving a generalized force component signal, the control system comprising:
a receiver for receiving a feedback signal having components in three dimensions, the feedback signal being based on the generalized force component signal and the motion component signal;
a processor for determining a desired trajectory of the manipulator based on the received feedback signal, on parameters of a dynamics model of the ground-spacecraft, and on parameters of a dynamics model of the flight-spacecraft, and for calculating a desired control command to be applied to the manipulator based on the determined desired trajectory; and
a controller for controlling dynamic behavior of the ground-spacecraft so that dynamic motion of the ground-spacecraft corresponds substantially to the desired dynamic motion of the flight-spacecraft in 0-G.

22. The control system of claim 21 further including a flexible state simulator for simulating a flexible component of the flight-spacecraft.

23. The control system of claim 21 wherein the motion component signal includes information relating to the position and velocity of the joints.

24. The control system of claim 21 wherein the controller includes means for controlling the dynamic behavior of the manipulator and the ground-spacecraft such that inertial parameters of the manipulator and the ground-spacecraft are combined so as to be substantially equivalent to desired target spacecraft inertial parameters.

25. The control system of claim 24 further including means for customizing the desired target spacecraft inertial parameters.

26. The control system of claim 21 further including a computer-readable memory having recorded thereon sequences and instructions for execution by the controller to control the dynamic behavior of the ground-spacecraft so that dynamic motion of the ground-spacecraft corresponds substantially to the desired dynamic motion of the flight-spacecraft in 0-G.

27. The control system of claim 21 wherein the controller includes means for issuing torque commands to the manipulator to achieve the desired dynamic motion of the flight-spacecraft in 0-G.

28. The control system of claim 27 wherein the controller includes means for issuing torque commands in response to manipulator joint angles and velocities measured at the joints.

29. The control system of claim 21 further comprising an estimator for performing one of: a computation of a gravitational force based on a measured attitude of an end effector of the manipulator; and an estimation of a gravitational force/moment of the ground-spacecraft on the six-axis force/moment sensor.

30. The control system of claim 29 further comprising means for determining the attitude by measuring manipulator joint angles.

31. The control system of claim 21 further comprising means for subtracting an estimated gravitational force from a received force feedback signal.

32. The control system of claim 29 further comprising a calibrator for performing one of: a measurement of the orientation of an end-effector of the manipulator with respect to the gravity vector, upon which measurements is based the estimated gravitational force/moment; and a measurement of values of mass and center of mass of the of the ground-spacecraft, upon which measurements is based the estimated gravitational force.

33. The control system of claim 21 wherein the controller is a non-linear controller.
